(19) United States
(12) Patent Application Publication
(10) Pub. No.: US 2003/0056333 A1
(43) Pub. Date: Mar. 27, 2003

(54) Weighted structures

(75) Inventor: Ross Boyle, Davenham (GB)

Correspondence Address: KOPPEL & JACOBS, AN ASSOCIATION OF PROFESSIONAL LAW CORPORATION, SUITE 107, 555 ST. CHARLES DRIVE, THOUSAND OAKS, CA, 91360, US

(73) Assignee: BANDEX VERWALTUNGS-GmbH

(21) Appl. No.: 09/963,860

(22) Filed: Sep. 25, 2001

(51) Int. Cl. E05D 9/00

(52) U.S. Cl. 16/404; 138/178; 160/349.1; 160/DIG. 6

(57) ABSTRACT

A weighted structure (13) for attachment along the foot of curtaining to ensure even hanging has a series of weights (4) attached at intervals along a cord (3). The assembly (2) of the cord (3) and weights (4) is enclosed within a tube (1). The tube (1) is applied to the assembly (2) by extrusion, the assembly (2) being passed through a die (8) together with molten plastics.

This invention relates to weighted structures for curtaining.

A conventional weighted tape, which is sewn along the foot of a curtain to ensure even hanging, comprises a series of lead ingots attached to a cord at equally spaced intervals and enclosed within a braided textile tube.

Tapes of this kind are customarily made with a range of different sizes of lead weights and for each size the product is manufactured by subjecting a preformed strung lead ingot arrangement to a textile braiding operation, typically using polyester yarn, followed by spooling and layering in continuous lengths into boxes.

This procedure is complicated and inconvenient; Production rates can be low and relatively expensive equipment may be required.

An object of the present invention is to provide an improved weighted structure which can be manufactured in a simple and convenient manner.

According to the invention therefore there is provided a weighted structure comprising a series of interconnected weights arranged at intervals within a tube, wherein said tube is an extruded plastics tube.

With this arrangement the weighted structure can be constructed in a simple and convenient manner. High production rates can be readily attained using relatively inexpensive apparatus, and different sizes of weights can be readily accommodated. In particular, conventional extrusion apparatus and techniques can conveniently be used.

With regard to the weights these may be lead ingots. However any other metal or other material may be used. In particular the weights may be beads or the like made from glass, glass powder, a ceramic material, steel, zinc or other material.

The plastics tube encloses and protects the weights whereby for example undesired contact with or contamination by or corrosion of the weights can be avoided even where the weighted structure is used in moisture or other adverse environmental conditions such as at the foot of shower curtaining.

The weights may be attached to a flexible elongate member which interconnects the weights, and this may comprise a textile cord, or wire or any other suitable member. The weights may be cast or crimped around this member or otherwise attached as desired.

Alternatively the weights may be wholly separate being interconnected solely by virtue of their enclosure within the tube.

The weights may be of cylindrical or rectangular or any other suitable regular or irregular shape.

The weights may be of a common size and shape or may differ; and they may be equally spaced or otherwise distributed.

The extruded tube may be formed from any suitable plastics material such as polyvinyl chloride (PVC). The tube may have a cylindrical or rectangular or other shape of substantially common external cross-section (e.g. external diameter) throughout, this being achieved by use of a self-supporting tube which has wall sections which straddle gaps between the weights, and/or a tube which has wall sections of increased thickness extending radially inwardly between the weights. Alternatively, the tube may fit closely around and between the weights so that it is depressed inwardly and is of reduced diameter between the weights giving an undulating or similar shape.

Especially in the case where the weights are solely interconnected by the tube, the tube is preferably closely in contact with the weights so as to restrict or prevent their movement particularly longitudinally of the tube.

Preferably the tube is relatively thin walled and flexible particularly so as to be essentially similar in flexibility to the braided textile tube of a conventional weighted curtain tape.

The tube may be thinner than a conventional braided textile tube particularly in the region of the weights whereby the tube contributes only minimally to the maximum diameter of the structure. This is important where lower density weights are used (e.g. glass). An increase in diameter of the weights to achieve adequate weight (relative to lead ingots) can be at least partially offset by a decrease in the tube thickness (relative to braided tubes).

Most preferably, the tube is formed by continuous extrusion around the preformed arrangement of interconnected weights.

Thus the flexible elongate member with attached weights may be drawn through a die of a plastics extrusion machine, molten plastics being applied around the member and weights. The hot extrusion may be cooled, e.g. by water quenching, and the resulting structure can be spooled and/or layered into a box or other storage medium.

The extrusion process may involve pressure extrusion whereby the plastics is applied under pressure into contact with the member and weights, or it may involve formation of the tube by tubing substantially without application of pressure.

It is visualised that the weight structure of the invention will be used for weighting the bottom edge of curtaining, whether fabric or plastics sheeting, although the structure may be used in any other suitable context for any other suitable purpose.

The invention will now be described further by way of example only and with reference to the accompanying drawings in which:

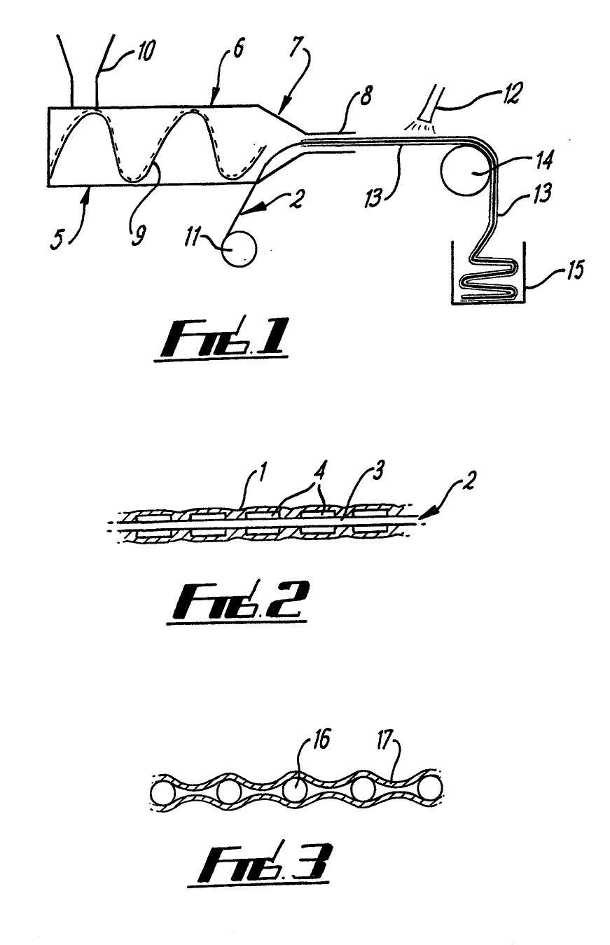

FIG. 1 is a diagrammatic representation of one form of apparatus for use in producing the structure of the invention;

FIG. 2 is a diagrammatic longitudinal section of one form of a weighted structure according to the invention; and

FIG. 3 is a view similar to FIG. 2 of an alternative structure.

Referring to FIG. 2, this shows a weighted structure intended to be attached along a bottom edge of a curtain to weight the curtain and thereby ensure even hanging.

The structure consists of a continuous walled (imperforate) water-proof tubular plastics cover 1 around an inner strung weight arrangement 2.

This inner strung weight arrangement comprises a flexible polyester cord 3 with lead ingots 4 cast or crimped or otherwise fixed around the cord 3 at closely spaced regular intervals along its length.

The ingots 4 are generally of a cylindrical shape of a substantially common diameter only slightly greater than that of the cord 3.

This inner arrangement 2 is pre-formed and is then provided with the tubular plastics cover 1, using the apparatus shown in FIG. 1.

This apparatus is essentially a conventional extruder having an input section 5, a multi-zone heated barrel 6, and an extruder head 7 with a circular die 8. There is a rotatably driven screw 9 within the section 5 and barrel 6 leading to the head 7.

PVC plastic in pellets or powder form is fed from a hopper 10 into the input section 5. From there is it fed by the screw 9 through the multi-zone barrel 6 where the temperature is raised to the melting point of the plastics, but below the temperature at which the lead ingots melt. From there the molten plastics is fed by the screw 9 under pressure through the extruder head 7 to the circular die 8.

The pre-formed inner arrangement 2 is fed from a supply roll 11 through the head 7 and the die 8.

The molten plastics which is forced through the die 8 form the tube 1 around the inner arrangement 2 and is quenched by a water spray 12.

The resulting weighted structure 13, i.e. the tube-enclosed inner arrangement, is produced continuously and is passed around a series of driven rollers 14 which draw the structure 13 from the die 8. The weighted structure is fed in layers into a box 15 and is cut when the box 15 is filled.

The molten plastics is applied under pressure around the inner arrangement and on cooling forms a generally cylindrical thin walled flexible tube 1 which follows the profile of the weights 4, as shown in FIG. 2.

With this procedure, a weighted structure, which may be similar in properties to conventional curtain-weighting braided-tube tape, can be made at a high production rate conveniently and relatively inexpensively.

As with the conventional product, different weights can be used, say 14 g, 25 g, 35 g, 50 g, 70 g, 100 g and 150 g/metre, such weights being of different diameters and therefore requiring different diameter dies.

The plastics material can be of any desired colour.

In accordance with conventional practice the weighted structure may be attached to the bottom edge of curtaining in any suitable manner e.g. by looped stitches around the structure and through the curtaining material or by enclosing the structure within a channel defined by an overturned portion of the bottom edge of the curtaining which portion is held in position above the structure by one or more lines of stitching through the curtaining material. Other techniques involving bonding, stitching, retention through slits or the like may also be used.

FIG. 3 shows an alternative embodiment comprising a series of weights 16 which may be made from a material other than lead, such as glass beads, encapsulated within an extruded plastic tube 17. The beads 16 are solely interconnected by the plastics tube 17 which fits tightly against the outer surface of the beads 16 and projects inwardly between and into contact with the beads 16.

This structure is made in like manner to FIG. 1 by feeding the beads 16 through a die of a plastics extrusion machine so that the tube 17 forms around the beads and contracts and/or is compressed into retaining contact with the beads as the tube forms and cools. The spacing between the beads prior to formation of the tube may be established and maintained by a feed screw or other similar compartmentalised feed device.

It is of course to be understood that the invention is not intended to be restricted to the details of the above embodiment which are described by way of example only.

Thus, for example, the invention is not restricted to use of PVC and other plastics may be used such as polypropylene and polyurethane. The weights need not be made from lead and other metals can be used.

1. A weighted structure comprising a series of interconnected weights arranged at intervals within a tube, wherein said tube is an extruded plastics tube.

2. A structure according to claim 1 wherein the weights are attached to a flexible elongate member.

3. A structure according to claim 2 wherein the flexible elongate member comprises a textile cord.

4. A structure according to claim 2 wherein the weights are cast around the flexible elongate member.

5. A structure according to claim 2 wherein the weights are crimped around the flexible elongate member.

6. A structure according to claim 1 wherein the weights are interconnected solely by the tube.

7. A structure according to claim 1 wherein the tube is a self supporting tube of substantially common external cross-section throughout.

8. A structure according to claim 1 wherein the tube is depressed radially inwardly between the weights.

9. A structure according to claim 1 wherein the tube is a thin walled flexible tube.

10. A structure according to claim 1 wherein the weights are lead ingots.

11. A structure according to claim 1 wherein the weights are beads made from a material selected from glass, ceramic, steel and zinc.

12. A method of making a weighted structure comprising a series of interconnected weights arranged at intervals within a tube, wherein the tube is formed by continuous extrusion around the weights.

13. A method according to claim 12 wherein a preformed arrangement of the weights attached to a flexible elongate member is drawn through a die of a plastics extrusion machine, molten plastics is applied around the member and weights of the arrangement, the plastics is cooled and the resulting weighted structure is spooled or layered into a storage medium.

14. A method according to claim 13 wherein the molten plastics is applied under pressure into contact with the member and weights.

15. Curtaining having a weighted structure applied to a bottom edge thereof, said structure comprising a series of interconnected weights arranged at intervals within a tube wherein said tube is an extruded plastics tube.
